(19) United States
(12) Patent Application Publication
(10) Pub. No.: US 2021/0094739 A1
(43) Pub. Date: Apr. 1, 2021

(54) SMART CARBON-OFFSET PACKAGING

(71) Applicant: Dell Products L. P., Round Rock, TX (US)

(72) Inventors: Sathish Kumar Bikumala, Round Rock, TX (US); John Peter Raphael Hughan, Austin, TX (US)

(21) Appl. No.: 16/585,473

(22) Filed: Sep. 27, 2019

(51) Int. Cl. B65D 65/46; G06Q 10/08

(52) U.S. Cl. CPC B65D 65/466; G06Q 10/0832; G06Q 10/0838

(57) ABSTRACT

In some examples, a server may receive an order to ship a product to a particular location. The server may instruct a fully automated warehouse to place the product in a container with one or more biodegradable inserts to cushion the product. The server may select a plurality of seeds based on one or more of (i) location information (e.g., weather conditions, soil data, location type), (ii) a requested seed type in the order, (iii) a carbon footprint of the product, and/or (iv) previously sent seeds. The server may instruct the warehouse to create a packet that includes the plurality of seeds and, in some cases, a predetermined amount of a fertilizer selected based at least in part on the plurality of seeds and the soil data. The after the packet is attached to the container, a courier may transport the container to the particular location.

### BACKGROUND OF THE INVENTION

### Field of the Invention

This invention relates generally to packaging used to ship a product to a customer that includes seeds embedded into the packaging, and more particularly to selecting the seeds based on factors, such as, for example, a customer location, seasonal (e.g., time of the year) weather conditions at the customer location, a type of soil in the customer location, a type of environment (e.g., apartment, house, or the like), what seeds were shipped to the customer in a previous order, a carbon footprint of the product being shipped, and the like.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

When a customer places an order for a product, such as a computing device or a related accessory (e.g., keyboard, mouse, display device, or the like), the packaging may be made using a recyclable material, such as cardboard. However, beyond placing the packaging in a recycle bin, the customer is not involved in addressing the carbon footprint caused by manufacturing or using the product.

### SUMMARY OF THE INVENTION

This Summary provides a simplified form of concepts that are further described below in the Detailed Description. This Summary is not intended to identify key or essential features and should therefore not be used for determining or limiting the scope of the claimed subject matter.

In some examples, a server may include one or more processors and one or more non-transitory computer-readable media storing instructions executable by the one or more processors to perform various operations. The server may receive an order to acquire (e.g., purchase or lease) a product (e.g., a computing device or a computer peripheral) and ship the product to a particular location. The server may instruct a fully automated warehouse to place the product in a container and place one or more inserts to cushion the product in the container. The one or more inserts may be comprised of a biodegradable starch (e.g., corn starch, wheat starch, or the like). The server may determine location information associated with the particular location, such as, for example, determining weather conditions associated with the particular location, determining soil data associated with soil in the particular location, and determining a location type of the particular location. For example, the location type be one of an apartment, a condominium, a townhouse, or a house. The server may determine a requested seed option specified by the customer in the order. The server may determine (i) a carbon footprint associated with the product, (ii) previously sent seeds that were sent to the particular location in a previous order. The server may select a plurality of seeds based on one or more of (i) the location information (e.g., weather conditions, soil data, location type), (ii) the requested seed option, (iii) the carbon footprint of the product, and/or (iv) the previously sent seeds. The server may instruct the warehouse to create a packet that includes the plurality of seeds. The server may select a fertilizer based at least in part on the plurality of seeds and the soil data. The server may instruct the warehouse to include a predetermined amount of the fertilizer in the packet that includes the plurality of seeds. The server may instruct the warehouse to attach the packet to the container. The server may instruct a courier to transport the container to the particular location.

### BRIEF DESCRIPTION OF THE DRAWINGS

A more complete understanding of the present disclosure may be obtained by reference to the following Detailed Description when taken in conjunction with the accompanying Drawings. In the figures, the left-most digit(s) of a reference number identifies the figure in which the reference number first appears. The same reference numbers in different figures indicate similar or identical items.

FIG. 1 is a block diagram of a system in which a product is shipped in a container to a customer location, according to some embodiments.

FIG. 2 is a block diagram of contents of a container, according to some embodiments.

FIG. 3 is a block diagram of a container including a packet that includes seeds, according to some embodiments.

FIG. 4 is a block diagram that includes planting a packet that includes seeds, according to some embodiments.

FIG. 5 is a flowchart of a process that includes selecting seeds for inclusion in a container, according to some embodiments.

FIG. 6 illustrates an example configuration of a computing device that can be used to implement the systems and techniques described herein.

### DETAILED DESCRIPTION

For purposes of this disclosure, an information handling system (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or video display. The information handling system may also include one or more buses operable to transmit communications between the various hardware components.

The systems and techniques described herein enable a company that ships direct to a customer to enable the customer to offset (at least partially) a carbon footprint of a product acquired (e.g., purchased or leased) by the customer. A carbon footprint is the total emissions caused when manufacturing a product, such as a computing device (e.g., smartwatch, smartphone, tablet, laptop, desktop or the like) or a peripheral (e.g., display device, keyboard, mouse, trackball, or the like), expressed as carbon dioxide equivalent. For example, greenhouse gases, including carbon dioxide, may be emitted when the product is being manufactured. The systems and techniques may determine various factors including, for example, determining (i) a location to where the product is being shipped, (ii) weather conditions (e.g., which season, current conditions, predicted conditions for the next month, and the like) associated with the location, (iii) soil-related information (e.g., type of soil, available nutrients in the soil, known nutrient deficiencies in the soil, moisture content, and the like), (iv) address-related information (e.g., does the customer live in an apartment, a condominium, a house, how much room does the customer have to grow plants, and the like), (v) previous order information (what seeds where previously shipped to the customer in previous orders), (vi) a carbon footprint created by manufacturing the product, and (vii) any customer-specified options (e.g., flower, shrub, fruit tree, or the like). Based on the various factors, the systems and techniques may select one or more seeds. In some cases, the systems and techniques may select a particular type of fertilizer, e.g., based on (i) the nutrient needs of the seeds and (ii) the chemical composition of the soil in the customer's location. The selected seeds and fertilizer may be placed in a packet, and the packet placed in a container used to ship the product to the customer.

After the customer receives the container that includes the product, the customer may bury at least the packet, including the seeds (and in some cases fertilizer), in soil. The systems and techniques may provide a data sheet with data on the seeds and instructions on where (e.g., dig a hole at least 6″ deep) and when (e.g., Spring months) to plant the seeds. The packet itself may be made using biodegradable materials. In some cases, in addition to the seeds and the fertilizer, the packet may include an accelerant to speed up the degradation of the packet. For example, at least a portion of the packet may be water soluble such that after the packet is buried, water from the soil (e.g., after a rainfall or after the customer waters the buried packet) may cause the packet to begin dissolving (e.g., biodegrading). The process of biodegradation may include three stages: biodeterioration, bio-fragmentation, and assimilation. Biodeterioration is a surface-level degradation that modifies the mechanical, physical, and chemical properties of the material and occurs when the material used to make the packet is exposed to abiotic factors in the outdoor environment and enables degradation by weakening the material's structure. Abiotic factors may include mechanical compression, light, temperature, and chemicals in the environment. Biodeterioration typically occurs as the first stage of biodegradation, but may, in some cases, occur in parallel with bio-fragmentation. A number of factors, including light, water, oxygen and temperature, may determine the rate of biodegradation.

For a relatively large container (e.g., at least one dimension greater than 12″), the customer may be instructed to bury the packet and place the remaining packaging materials (e.g., the remainder of the container) in a recycle bin. For example, the remainder of the container may be made using cardboard or another recyclable material. For a smaller container (e.g., at least one dimension 12″ or less), the entire container may be made using biodegradable materials and the customer may be instructed (e.g., in the seed data sheet that is included in the container) to bury the entire container including the packet. In such cases (e.g., where the entire container is buried), the container may be made using biodegradable materials. Biodegradable materials may include bamboo, mushrooms (or other fungi), starch (e.g., corn starch, wheat starch, or the like), wheat straw, or the other plant-based materials. Biodegradable materials may degrade after exposure to water (e.g., water soluble materials), air (e.g., oxidation), or both.

When the product is packed in the container before being shipped to the customer, inserts may be used to cushion the product. The inserts may include rigid inserts and smaller peanut-shaped inserts (referred to as packing peanuts). Rigid inserts may be shaped to cradle and protect the product from sudden movements and the unintended intrusion of foreign objects into the container. The packing peanuts, the rigid inserts, or both may be made from a starch, such as wheat starch, corn starch, or the like, and may be biodegradable. For example, inserts made using starch may easily dissolve in water. The customer may be instructed to bury the packet, place the inserts over the location where the packet was buried, and pour water over the inserts sufficient to dissolve the inserts. The starch may provide nutrition to the seeds.

As an example, a server may include one or more processors and one or more non-transitory computer-readable media storing instructions executable by the one or more processors to perform various operations. The operations may include receiving an order to acquire (e.g., purchase or lease) a product (e.g., a computing device or a computer peripheral) and ship the product to a particular location. The operations may include instructing a fully automated warehouse to place the product in a container. The operations may include instructing the warehouse to place one or more inserts to cushion the product in the container. The one or more inserts may be comprised of a biodegradable starch (e.g., corn starch, wheat starch, or the like). The operations may include determining location information associated with the particular location, such as, for example, determining weather conditions associated with the particular location, determining soil data associated with soil in the particular location, and determining a location type of the particular location. For example, the location type be one of an apartment, a condominium, a townhouse, or a house. The operations may include determining a requested seed option specified in the order. The operations may include determining a carbon footprint associated with the product. The operations may include determining previously sent seeds that were sent to the particular location in a previous order. The operations may include selecting a plurality of seeds based on one or more of (i) the location information (e.g., weather conditions, soil data, location type), (ii) the requested seed option, (iii) the carbon footprint of the product, and/or (iv) the previously sent seeds. The operations may include instructing the warehouse to create a packet that includes the plurality of seeds. The operations may include selecting a fertilizer based at least in part on the plurality of seeds and the soil data. The operations may include instructing the warehouse to include a predetermined amount of the fertilizer in the packet that includes the plurality of seeds. The operations may include instructing the warehouse to attach the packet to the container. The operations may include instructing a courier to transport the container to the particular location.

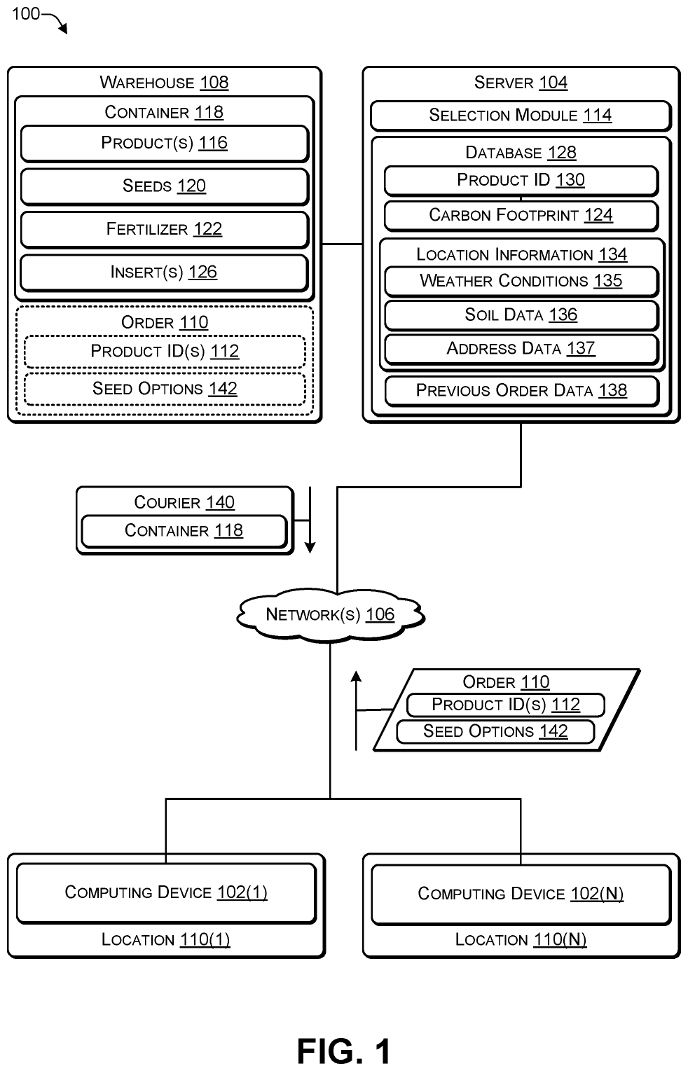

FIG. 1 is a block diagram of a system 100 in which a product is shipped in a container to a customer location, according to some embodiments. Multiple computing devices 102(1) to 102(N) (e.g., each associated with a customer) may be connected to a server 104 via a network 106. The server 104 may be an order fulfillment server of a direct to consumer manufacturer, such as Dell®. The server 104 may be directly connected (e.g., via an internal network) to a fully automated warehouse 108.

A customer associated with a computing device, such as the computing device 102(N), may place an order 110 to acquire (e.g., purchase or lease) one or more products identified by one or more product identifiers (IDs) 112 (e.g., each product identifier may uniquely identify a product). For example, each product ID 112 may be a stock keeping unit (SKU) or other identifier. In some cases, the order 110 may include seed options 142 in which the customer specifies a type of seeds (e.g., indoor plant, outdoor plant, flower, shrub, tree, or the like) to be sent with the products 126.

The server 104 may receive the order 110 from the computing device 102(N) located in location 110(N) and transmit the order 110 to the warehouse 108 for order fulfillment. For example, the warehouse 108 may place products 116 corresponding to the product IDs 112 in a container 118 for shipment to the location 110(N) associated with the order 110.

A selection module 114 may determine which seeds 120 to include with the product 116 in the container 118. For example, the selection module 114 may access a database 128. The database 128 may include multiple product IDs and each product ID may have an associated carbon footprint. For example, a representative product ID 130 may have an associated carbon footprint 124. Based on accessing the database 128, the selection module 114 may determine a sum of the carbon footprint of each of the product IDs 112 in the order 110, thereby determining a total carbon footprint of the order 110. For ease of understanding, assume the order 110 has a single product ID 130 having the carbon footprint 124.

The selection module 114 may access location information 134 associated with the location 110(N) where the order 110 is to be shipped. The location information 134 may include weather conditions 135, soil data 136, and address data 137. The weather conditions 135 may include information such as a particular season (e.g., spring, summer, fall, winter), a type of weather (e.g., rainy, dry, humid, and the like), how much yearly rainfall, temperatures (e.g., very hot is 95 degrees Fahrenheit or greater, hot is 80 to 94 degrees, medium is 60 to 79 degrees, cold is 40 to 59 degrees, very cold is below 40 degrees), and other weather related information. For example, the seeds 120 may be selected for a plant that can grow in the type of weather associated with the location 110(N). The soil data 136 may include information about the soil in the location 110(N), such as whether the soil is predominantly clay, sandy, silty, peaty, chalky, or loamy. For example, the seeds 120 may be selected for a plant that can grow in the type of soil associated with the location 110(N). The address data 137 may include information about the location 110(N), such as whether the location 110(N) is an apartment, a condominium, a single-family home, a business, a size of a plot of land on which a dwelling is located, and the like. For example, the seeds 120 may be selected for a plant that can be grown indoors when the address data 137 indicates that the order 110 is to be shipped to an apartment or a condominium. The seeds 120 may be selected for a plant that can be grown outdoors when the address data 137 indicates that the order 110 is to be shipped to a single-family home. The database 128 may include previous order data 138 that indicates what products the customer previously ordered and which seeds were previously shipped to the customer. For example, in some cases, the seeds 120 that are selected may be complimentary to the seeds that were previously shipped to the customer. Thus, the seeds 120 that are shipped with the products 116 may be selected based on (i) the carbon footprint 124 of the products 116, (ii) the weather conditions 135 associated with the location 110(N), (iii) the soil data 136 associated with the location 110(N), (iv) the address data 137 indicating the type of dwelling, (v) the previous order data 138, (vi) the seed options 142 selected by the customer, or any combination thereof.

In some cases, a fertilizer 122 may be included with the seeds 120. The selection module 114 may, after selecting the seeds 120, select the fertilizer 122 that is to be included in the container 118. The fertilizer 122 may provide nutrients, such as, for example, nitrogen, phosphorus, potassium, molybdenum, zinc, boron, copper, or any combination thereof. The fertilizer 122 may be formulated to be time released, e.g., the nutrients may be released over a period of time (e.g., several weeks). The fertilizer 122 may be selected based in part on the soil data 136 indicating that the soil in the location 110(N) lacks certain nutrients.

When the products 116 are packed in the container 118 before being shipped to the customer, one or more inserts 126 may be used to cushion the products 116. The inserts 126 may be rigid or small peanut-shaped inserts (referred to as packing peanuts). Rigid inserts may be shaped to cradle and protect the product from sudden movements and the unintended intrusion of foreign objects into the container. The inserts 126 may be made from a starch, such as wheat starch, corn starch, or the like, and may be biodegradable and provide nutrition to the seeds. For example, the inserts 126 may easily dissolve in water. The customer may be instructed to bury the seeds 120, place the inserts 126 over the location where the seeds 120 were buried, and pour water over the inserts 126 sufficient to dissolve the inserts 126.

Thus, after receiving the order 110, the server 104 may use the selection module 114 to select the seeds 120 for inclusion in the container 118 used to ship the products 116 to the customer location 110(N). The selection module 114 may select the fertilizer 122 for inclusion in the container 118.

The warehouse 108 may place the products 116 in the container 118 and use the inserts 126 to provide cushioning for the products 116. The warehouse 108 may include the seeds 120 (e.g., selected by the selection module 114) in the container 118. The warehouse 108 may include the fertilizer 122 (e.g., selected by the selection module 114) in the container 118. The warehouse 108 may ship the container 118 to the customer location 110(N) using a courier 140.

While the above examples describe an individual ordering the products 116 using the computing device 102(N), an enterprise customer, such as a business, may use the computing device 102(N) to place multiple orders, such as the order 110. For an enterprise customer, the customer may elect (i) not to receive any of the seeds 120, (ii) to receive a portion of the seeds 120, or (iii) receive seeds with each order. The enterprise may use the seeds for landscaping at the location 110(N), allow employees to take the seeds 120 home, donate the seeds 120 to a non-profit organization, or the like.

Thus, a customer who desires to at least partially offset the carbon footprint caused from manufacturing a computing device or a peripheral device may send an order for the computing device or peripheral to a server of a manufacturer. The order may specify a type of seeds that the user desires to receive. The server may receive the order and use a selection module to identify seeds based on various factors, including the (i) the carbon footprint of the products, (ii) the weather conditions associated with the customer location (e.g., the location to which the products are being shipped), (iii) the soil data associated with the location, (iv) the address data indicating the type of dwelling, (v) the previous order data, (vi) the seed options selected by the customer, or any combination thereof. In some cases, the selection module may select fertilizer suitable for the seeds based on (i) the nutrient needs of the seeds and (ii) the soil at the customer's location. The seeds and the fertilizer may be included in a container used to ship the products via a courier to the customer's location. The customer may receive the ordered products in a container that includes the seeds and, in some cases, fertilizer. The customer may plant the seeds and grow a flower, a plant, a tree, a shrub, or the like to at least partially offset the carbon footprint created by manufacturing the products.

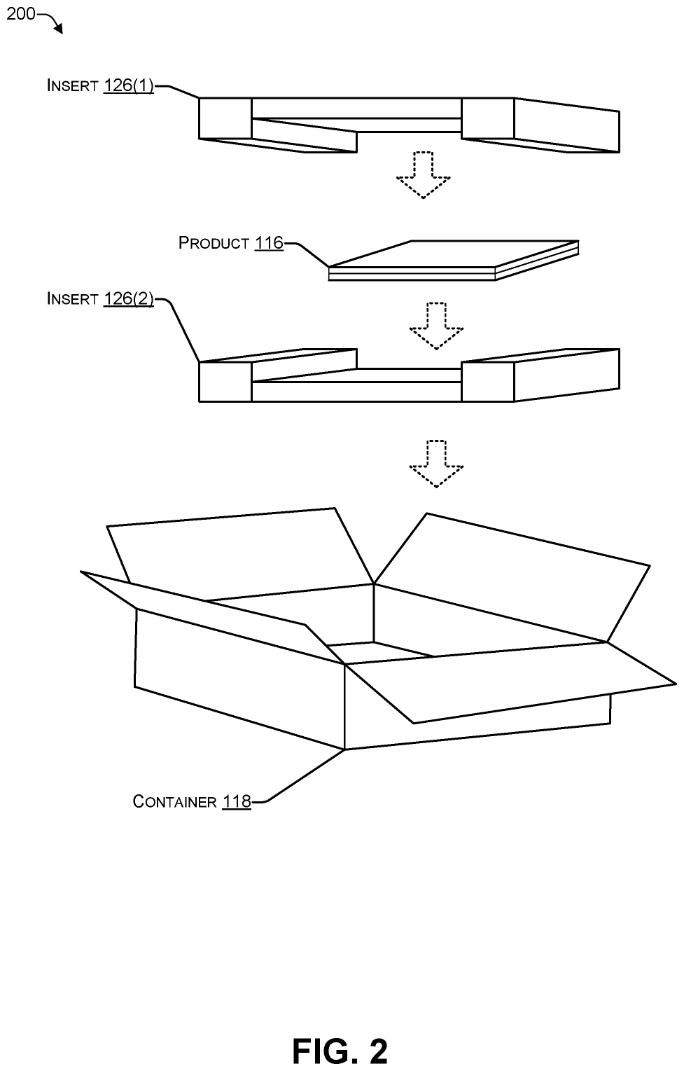

FIG. 2 is a block diagram 200 of contents of a container, according to some embodiments. In the container 118, the product 116 is cushioned from shocks that may be encountered during delivery by placing the inserts 126(1), 126(2) around the product 116. The inserts 126 may include recyclable materials (e.g., cardboard or other paper-based materials) or biodegradable materials (e.g., corn starch, wheat starch, or the like).

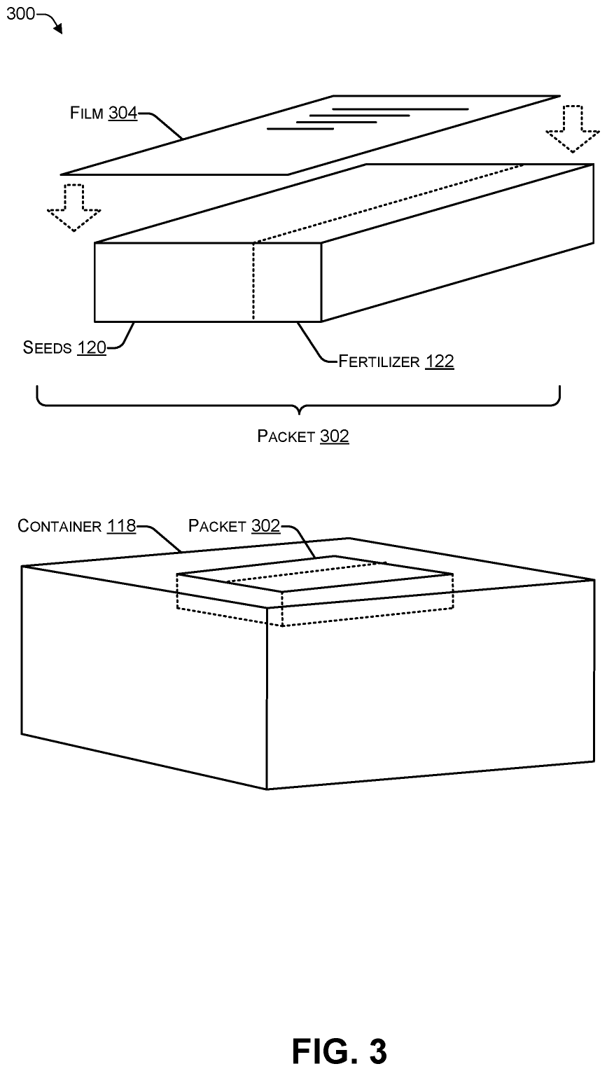

FIG. 3 is a block diagram 300 of a container including a packet that includes seeds, according to some embodiments. The container 118 may include a packet 302. For example, the product 116 of FIG. 1 may be placed between the inserts 126 and then placed into the container 118 in a first assembly line. Substantially at the same time, the selection module 114 of FIG. 1, may instruct the warehouse 108 to add the seeds 120 and, in some cases, the fertilizer 122, on a second assembly line, to a packet 302. For example, the packet 302 may include a first compartment to store the seeds 120 and a second compartment to store the fertilizer. The packet 302 may then be placed (e.g., inserted) into a cavity of the container 118. In this way, the customer may remove the packet 302 from the container 118, bury the packet 302, and place the remainder of the container 118 (e.g., made from cardboard or another recyclable material) in a recycle bin.

The packet 302 may contribute to a structural integrity of the container 118 by preventing the container 118 from deforming when pressure is applied to one or more of the sides of the container 118. The packet 302 may include the seeds 120 and, in some cases, the fertilizer 122. A film 304 may be placed over a top surface of the packet 302 to prevent the seeds 120 (and the fertilizer 122) from being released while the container 118 is in transit to the customer. In some cases, the film 304 may be biodegradable, such as a biodegradable plastic film made from plant materials, such as, for example, corn, potatoes, wheat, orange peels, starch, plants, and the like. For example, the customer may be instructed to bury the packet 302 and pour a certain quantity of water on top of the location where the packet 302 is buried. The water may accelerate the breakdown of the film 304 and cause the film 304 to dissolve, releasing the seeds 120 (and fertilizer 122). In other cases, the coating 304 may include a recyclable plastic. For example, the customer may be instructed to remove the film 304 before burying the packet 302 in soil and to place the firm 304 in a recycle bin.

For a small container (e.g., each of the dimensions of length, width, or height are N inches or less, e.g., N=12, 10, 8, 6 or the like), the packet 302 may not be removeable and the entire container 118 may be biodegradable. In such cases, the customer may be instructed to leave the packet 302 embedded in the container 118 and to bury the entire container 118 in soil.

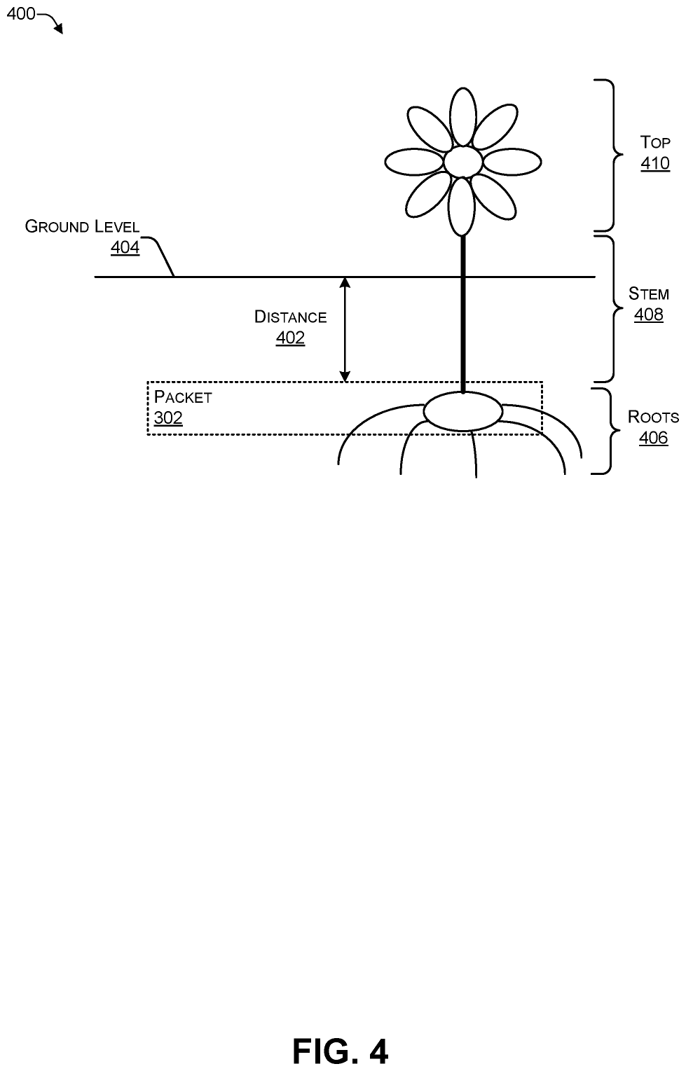

FIG. 4 is a block diagram 400 that includes planting a packet that includes seeds, according to some embodiments. The container 118 may include a “how to plant your seeds” instructional sheet that instructs the customer to dig a particular sized hole in soil sufficient to accommodate the packet 302 (or a small container), place the packet 302 into the hole, and place soil on top of the packet 302. For example, the customer may be instructed to dig a hole that is a predetermined distance 402 below ground level 404.

After the customer has buried the packet 302, the customer may be instructed to periodically water the packet 302. Over time, the seeds may sprout to create a root system 406, a stem 408, and a top 410 (e.g., leaves and/or a flower). The plant that is created using the seeds in the packet 302 may use photosynthesis to convert light into chemical energy. The plant may consume carbon dioxide while releasing oxygen as a waste product, thereby partially offsetting the carbon footprint created by manufacturing the products 116 of FIG. 1.

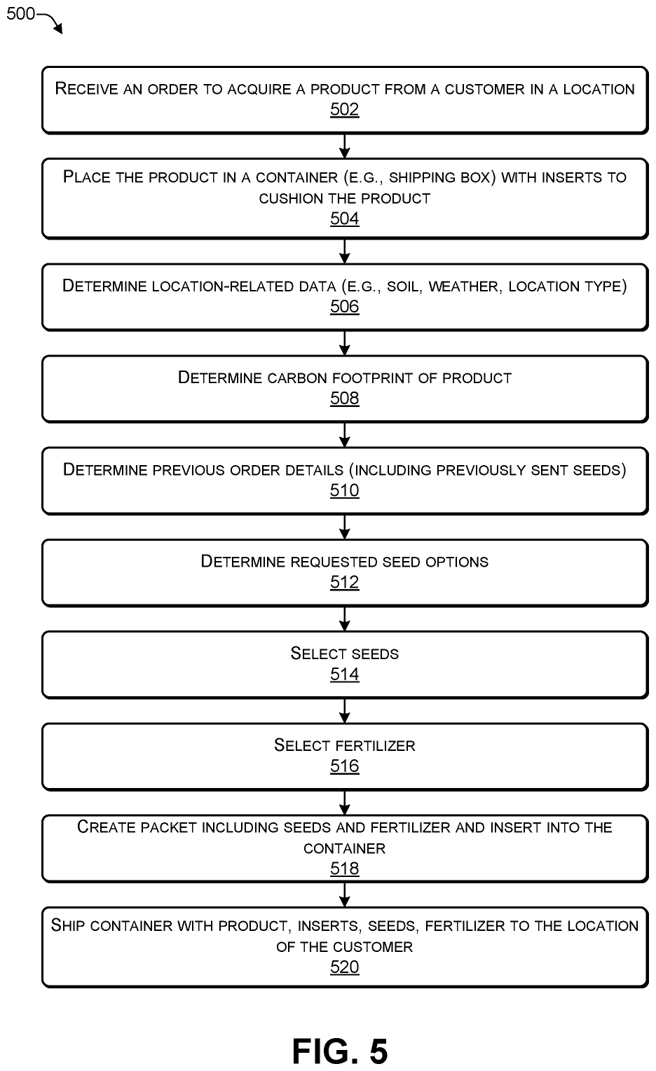

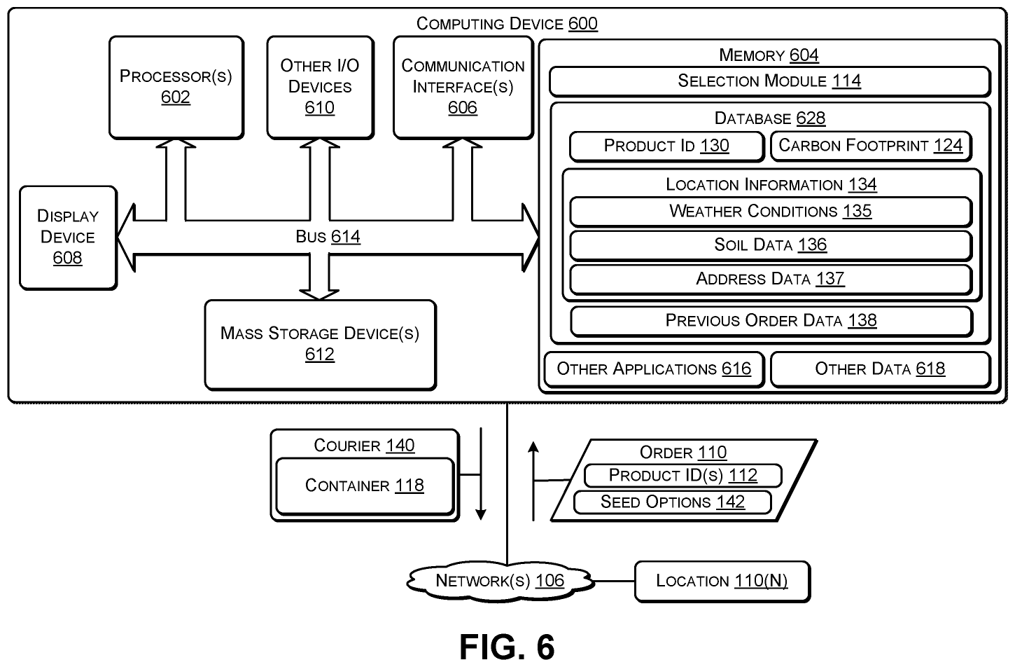

In the flow diagram of FIGS. 5 and 6, each block represents one or more operations that can be implemented in hardware, software, or a combination thereof. In the context of software, the blocks represent computer-executable instructions that, when executed by one or more processors, cause the processors to perform the recited operations. Generally, computer-executable instructions include routines, programs, objects, modules, components, data structures, and the like that perform particular functions or implement particular abstract data types. The order in which the blocks are described is not intended to be construed as a limitation, and any number of the described operations can be combined in any order and/or in parallel to implement the processes. For discussion purposes, the processes 500 and 600 are described with reference to FIGS. 1, 2, 3, and 4, as described above, although other models, frameworks, systems and environments may be used to implement these processes.

FIG. 5 is a flowchart of a process 500 that includes selecting seeds for inclusion in a container, according to some embodiments. For example, the process 500 may be performed by the server 104 of FIG. 1.

At 502, the process may receive an order to acquire a product from a customer in a particular location. At 504, the product may be placed in a container (e.g., a shipping box) with inserts to cushion the product. For example, in FIG. 1, the server 104 may receive the order 110 from the computing device 102(N) located in location 110(N) and transmit the order 110 to the warehouse 108 for order fulfillment. The warehouse 108 may place products 116 corresponding to the product IDs 112 in a container 118 for shipment to the location 110(N) associated with the order 110. The warehouse 108 may include the inserts 126 to cushion the products 116 during transport.

At 506, the process may determine location-related data, such as, for example, soil details, weather conditions, location type, and the like. At 508, the process may determine a carbon footprint associated with manufacturing the product. At 510, the process may determine previous order details, including seeds previously sent to the customer. At 512, the process may determine seeds options requested in the order. At 514, the process may select one or more seeds for inclusion in the container. At 516, the process may select seeds based in part on the location, the carbon footprint, previously sent seeds, and requested seeds. For example, in FIG. 1, the selection module 114 may determine which seeds 120 to include with the product 116 in the container 118 by accessing the database 128. The database 128 may determine a carbon footprint of products 116 in the order 110. The selection module 114 may access location information 134 associated with the location 110(N) where the order 110 is to be shipped. The location information 134 may include weather conditions 135, soil data 136, and address data 137. The selection module 114 may select the seeds 120 that are shipped with the products 116 based on (i) the carbon footprint 124 of the products 116, (ii) the weather conditions 135 associated with the location 110(N), (iii) the soil data 136 associated with the location 110(N), (iv) the address data 137 indicating the type of dwelling, (v) the previous order data 138, (vi) the seed options 142 selected by the customer, or any combination thereof.

At 518, a packet that includes the seeds and fertilizer may be created and inserted into the container. At 520, the process may ship the container including the product, one or more inserts, the seeds, and the fertilizer, via a courier, to the customer's location. For example, in FIG. 1, the selection module 114 may select the fertilizer 122. The warehouse 108 may place the products 116 in the container 118 and use the inserts 126 to provide cushioning for the products 116. The warehouse 108 may include the seeds 120 (e.g., selected by the selection module 114) in the container 118. The warehouse 108 may include the fertilizer 122 (e.g., selected by the selection module 114) in the container 118. The warehouse 108 may ship the container 118 to the customer location 110(N) using the courier 140.

FIG. 6 illustrates an example configuration of a computing device 600 that can be used to implement the systems and techniques described herein, such as for example, the computing devices 102 and the server 104 of FIG. 1. For illustration purposes, the computing device 600 is illustrated in FIG. 6 as implementing the server 104 of FIG. 1.

The computing device 600 may include one or more processors 602 (e.g., CPU, GPU, or the like), a memory 604, communication interfaces 606, a display device 608, other input/output (I/O) devices 610 (e.g., keyboard, trackball, and the like), the sensors 206, and one or more mass storage devices 612 (e.g., disk drive, solid state disk drive, or the like), configured to communicate with each other, such as via one or more system buses 614 or other suitable connections. While a single system bus 614 is illustrated for ease of understanding, it should be understood that the system buses 614 may include multiple buses, such as a memory device bus, a storage device bus (e.g., serial ATA (SATA) and the like), data buses (e.g., universal serial bus (USB) and the like), video signal buses (e.g., ThunderBolt®, DVI, HDMI, and the like), power buses, etc.

The processors 602 are one or more hardware devices that may include a single processing unit or a number of processing units, all of which may include single or multiple computing units or multiple cores. The processors 602 may include a graphics processing unit (GPU) that is integrated into the CPU or the GPU may be a separate processor device from the CPU. The processors 602 may be implemented as one or more microprocessors, microcomputers, microcontrollers, digital signal processors, central processing units, graphics processing units, state machines, logic circuitries, and/or any devices that manipulate signals based on operational instructions. Among other capabilities, the processors 602 may be configured to fetch and execute computer-readable instructions stored in the memory 604, mass storage devices 612, or other computer-readable media.

Memory 604 and mass storage devices 612 are examples of computer storage media (e.g., memory storage devices) for storing instructions that can be executed by the processors 602 to perform the various functions described herein. For example, memory 604 may include both volatile memory and non-volatile memory (e.g., RAM, ROM, or the like) devices. Further, mass storage devices 612 may include hard disk drives, solid-state drives, removable media, including external and removable drives, memory cards, flash memory, floppy disks, optical disks (e.g., CD, DVD), a storage array, a network attached storage, a storage area network, or the like. Both memory 604 and mass storage devices 612 may be collectively referred to as memory or computer storage media herein and may be any type of non-transitory media capable of storing computer-readable, processor-executable program instructions as computer program code that can be executed by the processors 602 as a particular machine configured for carrying out the operations and functions described in the implementations herein.

The computing device 600 may include one or more communication interfaces 606 for exchanging data via the network 106. The communication interfaces 606 can facilitate communications within a wide variety of networks and protocol types, including wired networks (e.g., Ethernet, DOCSIS, DSL, Fiber, USB etc.) and wireless networks (e.g., WLAN, GSM, CDMA, 802.11, Bluetooth, Wireless USB, ZigBee, cellular, satellite, etc.), the Internet and the like. Communication interfaces 606 can also provide communication with external storage, such as a storage array, network attached storage, storage area network, cloud storage, or the like.

The display device 608 may be used for displaying content (e.g., information and images) to users. Other I/O devices 610 may be devices that receive various inputs from a user and provide various outputs to the user, and may include a keyboard, a touchpad, a mouse, a printer, audio input/output devices, and so forth.

The computer storage media, such as memory 604 and mass storage devices 612, may be used to store software and data, as illustrated in FIG. 6.

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer storage devices. Thus, the processes, components and modules described herein may be implemented by a computer program product.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

Although the present invention has been described in connection with several embodiments, the invention is not intended to be limited to the specific forms set forth herein. On the contrary, it is intended to cover such alternatives, modifications, and equivalents as can be reasonably included within the scope of the invention as defined by the appended claims.

What is claimed is:

1. A method comprising:
receiving, by one or more processors, an order to acquire a product and ship the product to a particular location;
instructing, by the one or more processors, a warehouse to place the product in a container;
instructing, by the one or more processors, the warehouse to place one or more inserts to cushion the product in the container;
determining, by the one or more processors, location information associated with the particular location;
selecting, by the one or more processors and based at least in part on the location information, a plurality of seeds;
instructing, by the one or more processors, the warehouse to create a packet that includes the plurality of seeds;
instructing, by the one or more processors, the warehouse to attach the packet to the container; and
instructing, by the one or more processors, a courier to transport the container to the particular location.

2. The method of claim 1, further comprising:
determining a requested seed option specified in the order; and
selecting, based at least in part on the requested seed option specified in the order, the plurality of seeds.

3. The method of claim 1, wherein determining location information associated with the particular location comprises:
determining weather conditions associated with the particular location;
determining soil data associated with soil in the particular location; and
determining a location type of the particular location, the location type comprising one of an apartment, a condominium, a townhouse, or a house.

4. The method of claim 1, further comprising:
determining a carbon footprint associated with the product; and
selecting, based at least in part on the carbon footprint associated with the product, the plurality of seeds.

5. The method of claim 1, further comprising:
determining previously sent seeds that were sent to the particular location in a previous order; and
selecting, based at least in part on the previously sent seeds, the plurality of seeds.

6. The method of claim 1, further comprising:
determining soil data associated with soil in the particular location;
selecting a fertilizer based at least in part on:
the plurality of seeds; and
the soil data; and
instructing the warehouse to include a predetermined amount of the fertilizer in the packet that includes the plurality of seeds.

7. The method of claim 1, wherein:
the one or more inserts are comprised of a biodegradable starch.

8. A server comprising:
one or more processors; and
one or more non-transitory computer readable media storing instructions executable by the one or more processors to perform operations comprising:
receiving an order to acquire a product and ship the product to a particular location;
instructing a warehouse to place the product in a container;
instructing the warehouse to place one or more inserts to cushion the product in the container;
determining location information associated with the particular location;
selecting, based at least in part on the location information, a plurality of seeds;
instructing the warehouse to create a packet that includes the plurality of seeds;
instructing the warehouse to attach the packet to the container; and
instructing a courier to transport the container to the particular location.

9. The server of claim 8, the operations further comprising:
determining a requested seed option specified in the order; and
selecting, based at least in part on the requested seed option specified in the order, the plurality of seeds.

10. The server of claim 8, wherein determining location information associated with the particular location comprises:
determining weather conditions associated with the particular location;
determining soil data associated with soil in the particular location; and
determining a location type of the particular location, the location type comprising one of an apartment, a condominium, a townhouse, or a house.

11. The server of claim 8, the operations further comprising:
determining a carbon footprint associated with the product; and
selecting, based at least in part on the carbon footprint associated with the product, the plurality of seeds.

12. The server of claim 8, the operations further comprising:
determining previously sent seeds that were sent to the particular location in a previous order; and
selecting, based at least in part on the previously sent seeds, the plurality of seeds.

13. The server of claim 8, the operations further comprising:
determining soil data associated with soil in the particular location;
selecting a fertilizer based at least in part on:
the plurality of seeds; and
the soil data; and
instructing the warehouse to include a predetermined amount of the fertilizer in the packet that includes the plurality of seeds.

14. One or more non-transitory computer readable media storing instructions executable by one or more processors to perform operations comprising:
receiving an order to acquire a product and ship the product to a particular location;
instructing a warehouse to place the product in a container;
instructing the warehouse to place one or more inserts to cushion the product in the container;
determining location information associated with the particular location;
selecting, based at least in part on the location information, a plurality of seeds;
instructing the warehouse to create a packet that includes the plurality of seeds;
instructing the warehouse to attach the packet to the container; and
instructing a courier to transport the container to the particular location.

15. The one or more non-transitory computer readable media of claim 14, the operations further comprising:
determining a requested seed option specified in the order; and
selecting, based at least in part on the requested seed option specified in the order, the plurality of seeds.

16. The one or more non-transitory computer readable media of claim 14, wherein determining location information associated with the particular location comprises:
determining weather conditions associated with the particular location;
determining soil data associated with soil in the particular location; and
determining a location type of the particular location, the location type comprising one of an apartment, a condominium, a townhouse, or a house.

17. The one or more non-transitory computer readable media of claim 14, the operations further comprising:
determining a carbon footprint associated with the product; and
selecting, based at least in part on the carbon footprint associated with the product, the plurality of seeds.

18. The one or more non-transitory computer readable media of claim 14, the operations further comprising:
determining previously sent seeds that were sent to the particular location in a previous order; and
selecting, based at least in part on the previously sent seeds, the plurality of seeds.

19. The one or more non-transitory computer readable media of claim 14, the operations further comprising:
determining soil data associated with soil in the particular location;
selecting a fertilizer based at least in part on:
the plurality of seeds; and
the soil data; and
instructing the warehouse to include a predetermined amount of the fertilizer in the packet that includes the plurality of seeds.

20. The one or more non-transitory computer readable media of claim 14, wherein:
the one or more inserts are comprised of a biodegradable starch.
